(19) United States
(12) Patent Application Publication
(10) Pub. No.: US 2023/0183130 A1
(43) Pub. Date: Jun. 15, 2023

(54) METHOD OF MANUFACTURING GLASS SUBSTRATE HAVING PENETRATING STRUCTURE, AND GLASS SUBSTRATE

(71) Applicant: AGC Inc., Tokyo (JP)

(72) Inventors: Mamoru ISOBE, Tokyo (JP); Kohei HORIUCHI, Tokyo (JP); Katsuaki MIYATANI, Tokyo (JP); Naoki UEMURA, Tokyo (JP); Akiko OSAKI, Tokyo (JP)

(73) Assignee: AGC Inc., Tokyo (JP)

(21) Appl. No.: 18/059,034

(22) Filed: Nov. 28, 2022

(30) Foreign Application Priority Data
Dec. 15, 2021 (JP) 2021-203516

(51) Int. Cl. C03C 23/00; C03C 15/00; C03C 19/00

(52) U.S. Cl. CPC C03C 23/0025; C03C 15/00; C03C 19/00; C03C 23/0075

(57) ABSTRACT

A method of manufacturing a glass substrate having a penetrating structure, the method includes: (1) preparing a glass substrate that has a first surface and a second surface opposite to each other, and includes 3 mol % to 30 mol % of B₂O₃ in terms of oxide; (2) having the glass substrate irradiated with a laser from a first surface side, to form an initial penetrating structure; (3) wet etching the glass substrate having the initial penetrating structure formed; (4) polishing the wet-etched glass substrate from the first surface side, by using an abrasive including acid-soluble abrasive grains; and (5) cleaning the glass substrate with an acid solution.

### CROSS-REFERENCE TO RELATED APPLICATIONS

The present application is based upon and claims the benefit of priority to Japanese Patent Application No. 2021-203516 filed on Dec. 15, 2021, the entire contents of which are hereby incorporated by reference.

### BACKGROUND OF THE INVENTION

### 1. Field of the Invention

The present disclosure relates to a method of manufacturing a glass substrate having a penetrating structure, and a glass substrate.

### 2. Description of the Related Art

Glass substrates having a penetrating structure such as a through hole have many applications including glass filters, glass interposers, substrate integrated waveguides (SIW), and post-wall waveguides.

Such a glass substrate is manufactured by having a glass substrate irradiated with a laser to form an initial penetrating structure, and then, wet etching the glass substrate. The wet etching is carried out to improve the shape of the initial penetrating structure, and to obtain a desired penetrating structure and a thickness of the glass substrate (e.g., Japanese Laid-Open Patent Application No. 2000-302488).

The inventors of the present application have noticed that, in the case of using a glass substrate having a predetermined composition, after wet etching an initial penetrating structure, in some cases, a “bump portion” that protrudes more than other portions is generated in the vicinity of an opening of the penetrating structure.

Such a bump portion may cause a problem when using the glass substrate for a glass interposer or the like.

For example, a glass interposer is constructed by filling a through hole with a conductive member by a plating method. In order to fill the through hole with this conductive member, first, it is necessary to form a thin seed layer on the glass substrate as a base layer for plating. However, if a bump portion exists on the surface of the glass substrate, a place where a seed layer is not formed may occur in the vicinity of such a bump portion, and as a result, there is a likelihood that a certain place in the through hole is not filled with the conductive member.

Also, in some cases, a glass substrate having a penetrating structure may be joined with another member to be used as a laminate. However, if a bump portion is present on a surface of the glass substrate, a problem may arise in that when joining with the other member, a gap is generated at the interface, sufficient joining strength is not obtained, and thereby, delamination tends to occur easily.

### SUMMARY

In the present disclosure, a method of manufacturing a glass substrate having a penetrating structure is provided, that includes:

(1) preparing a glass substrate that has a first surface and a second surface opposite to each other, and includes 3 mol % to 30 mol % of B₂O₃ in terms of oxide,
(2) having the glass substrate irradiated with a laser from a first surface side, to form an initial penetrating structure,
(3) wet etching the glass substrate having the initial penetrating structure formed,
(4) polishing the wet-etched glass substrate from the first surface side, by using an abrasive including acid-soluble abrasive grains, and
(5) cleaning the glass substrate with an acid solution.

Also, in the present disclosure, a method of manufacturing a glass substrate having a penetrating structure is provided, that includes:

(1) preparing a glass substrate that has a first surface and a second surface opposite to each other, and includes 3 mol % to 30 mol % of B₂O₃ in terms of oxide,
(2) having the glass substrate irradiated with a laser from a first surface side, to form an initial penetrating structure,
(3) wet etching the glass substrate having the initial penetrating structure formed,
(4) polishing the wet-etched glass substrate on the first surface and the second surface, by using an abrasive including acid-soluble abrasive grains, and
(5) cleaning the glass substrate with an acid solution.

Further, in the present disclosure, a glass substrate is provided that includes a first surface and a second surface opposite to each other,

wherein the glass substrate contains 3 mol % to 30 mol % of B₂O₃ in terms of oxide, and has a penetrating structure that penetrates from the first surface to the second surface,

wherein the penetrating structure has a first opening on the first surface, and as viewed from a first surface side, when a region up to 10-μm outward from a contour of the first opening is referred to as a surrounding region, a maximum height in the surrounding region is greater than or equal to 0 μm and less than or equal to 1 μm, and

wherein an arithmetic mean roughness Ra is less than or equal to 1 nm in a region outside the surrounding region of the first surface.

### BRIEF DESCRIPTION OF DRAWINGS

FIG. 1 is a diagram schematically illustrating an example of a form of a cross section of a glass substrate in which a bump portion is formed around an opening;

FIG. 2 is a diagram schematically illustrating an example of a flow of a method of manufacturing a glass substrate according to the one embodiment in the present disclosure;

FIG. 3 is a perspective view schematically illustrating an example of a glass substrate to be processed, that is used in the method of manufacturing the glass substrate according to the one embodiment in the present disclosure;

FIG. 4 is a diagram schematically illustrating a cross section of the glass substrate having an initial through hole is formed in the method of manufacturing the glass substrate according to the one embodiment in the present disclosure;

FIG. 5 is a diagram schematically illustrating a cross section of the glass substrate after a wet etching process in the method of manufacturing the glass substrate according to the one embodiment in the present disclosure;

FIG. 6 is a diagram schematically illustrating an example of a flow of the method of manufacturing the glass substrate according to another embodiment in the present disclosure;

FIG. 7 is a schematic view of a cross section of a glass substrate according to the one embodiment in the present disclosure;

FIG. 8 is a diagram schematically illustrating a profile of a first opening and its vicinity along a cross section through the center of a through hole, before a polishing process in Example 1;

FIG. 9 is a diagram schematically illustrating a profile of the first opening and its vicinity along a cross section through the center of the through hole, after the polishing process in Example 1;

FIG. 10 is a diagram illustrating a profile of a first opening and its vicinity along a cross section through the center of a through hole before polishing process in Example 11; and

FIG. 11 is a diagram illustrating an example of a result of SEM-EDX analysis of an inner wall of the through hole in Example 11.

### DESCRIPTION OF THE PREFERRED EMBODIMENTS

According to the present disclosure, a method of manufacturing a glass substrate that can significantly suppress bump portions that may be generated around openings of a penetrating structure can be provided.

In addition, a glass substrate having such bump portions suppressed significantly can be provided.

In the following, with reference to the drawings, one embodiment in the present disclosure will be described.

In the present application, a “penetrating structure” means any structure in which a through hole, a through groove, or the like penetrates a glass substrate.

Also, an “initial penetrating structure” means a penetrating structure formed on a glass substrate by laser irradiation before wet etching is carried out. Therefore, the “initial penetrating structure” is included in the “penetrating structure”.

Normally, an initial penetrating structure is formed during a course of processing a glass substrate, and after completion of the processing, becomes a “penetrating structure” as the final form.

Also, in the present application, in accordance with these definitions, the terms “through hole” and “initial through hole”, and “through groove” and “initial through groove” are used. For example, an initial through hole is formed during a course of processing a glass substrate, and after completion of the processing, becomes a “through hole” as the final form.

Note that in the present application, although the definitions of “hole” and “groove” do not need to be strict; in general, “hole” is used for a structure having an approximately circular curved opening, and “groove” is used for a structure having an elongated opening such as a rectangle. However, it should be noted that the boundary between the two is not necessarily clear.

In most of the following description, in order to make it easier to understand, a through hole is assumed as an example of the penetrating structure. However, this is merely one example, and it is obvious that the following description can be applied to other penetrating structures, such as a penetrating groove.

As described above, the inventors of the present application have noticed that, in the case of using a glass substrate having a predetermined composition, after wet etching an initial through hole, in some cases, a “bump portion” that protrudes more than other portions is generated in the vicinity of an opening of the through hole on the surface of the glass substrate.

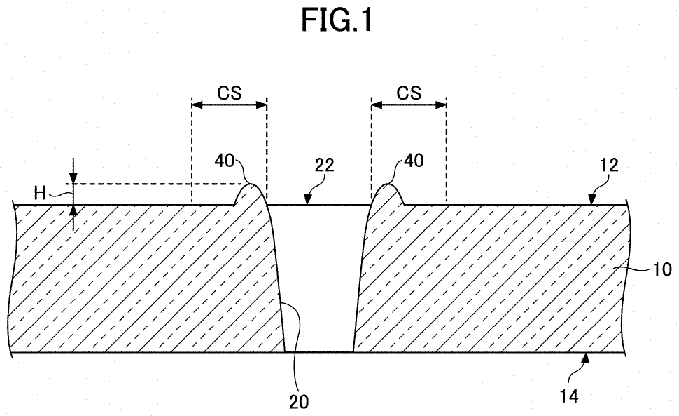

FIG. 1 schematically illustrates an example of a form of a cross section of a glass substrate in which such a bump portion is formed around an opening.

As illustrated in FIG. 1, a through hole 20 is formed in a glass substrate 10, penetrating from a first surface 12 to a second surface 14. Note that in this example in FIG. 1, it is assumed that the first surface 12 of the glass substrate 10 is a laser-irradiated surface. The through hole 20 has a first opening 22 on the first surface 12.

As can be seen from FIG. 1, in the vicinity around the first opening 22, a bump portion 40 that protrudes relative to the first surface 12 of the glass substrate 10 is generated. The bump portion 40 normally has a height H within a range of 0.1 μm to 5 μm.

Note that the form of the bump portion 40 illustrated in FIG. 1 is merely an example, and the bump portion 40 may exist in various forms such as a spiky form, other than a “lump-shaped” form.

Here, as illustrated in FIG. 1, when the through hole 20 is viewed from the first surface 12 side, an area up to 10-μm outward from the contour of the first opening 22 is specifically referred to as a “surrounding region” CS. The bump portion 40 tends to be generated in the surrounding region CS.

Such a bump portion 40 may cause a problem when using the glass substrate 10 for a glass interposer or the like.

For example, a glass interposer is constructed by filling the through hole 20 with a conductive member by a plating method. In order to fill the through hole 20 with this conductive member, first, it is necessary to form a thin seed layer (having a thickness around a few hundred nm) on the glass substrate 10 as a base layer for plating on the first surface 12 including the surrounding region CS. However, if the bump portion 40 is present in the surrounding region CS, there may exist a location on the first surface 12 where such a seed layer is not formed, and as a result, there is a likelihood that the through hole 20 may not be filled sufficiently with the conductive member.

Also, in some cases, the glass substrate 10 having the through hole 20 may be joined with another member to be used as a laminate. However, if the bump portion 40 is present on the first surface 12 of the glass substrate 10, a problem arises in that when joining with the other member, a gap is generated at the interface, sufficient joining strength is not obtained, and thereby, delamination tends to occur easily.

Note that according to findings of the inventors of the present application, a bump portion 40 tends to be generated in a glass substrate 10 that contains 3 mol % to 30 mol % of B₂O₃ in terms of oxide. Therefore, as possible causes of generation of a bump portion 40, the following issues may be considered.

In the case of forming a through hole 20 in a glass substrate 10, first, the first surface 12 is irradiated with a laser to form an initial through hole. At this time, if laser irradiation is carried out under a condition of the heat input being high, a heat-induced alteration layer is formed in the vicinity around the initial through hole. In particular, as boron is a volatile component, on the glass substrate 10 that includes a large amount of boron, a boron-deficient alteration layer is more likely to be formed than in a bulk portion.

Also, a portion of the alteration layer has a more silica-rich composition than the bulk portion; therefore, the etching rate in wet etching is reduced compared to the bulk portion.

Therefore, when the glass substrate 10 is wet etched, a portion of the alteration layer remains due to the etch-rate difference between the bulk portion and the alteration layer that is harder to be etched. As a result, it is considered that on the first surface 12, the bump portion 40 is formed due to the alteration layer remaining in the surrounding region CS.

Note that the mechanism described above was considered based on the current findings of the inventors of the present application, and possibly, the bump portion 40 may be generated by another cause.

In any case, the presence of a bump portion 40 is likely to cause a number of problems.

Under awareness of these problems involved, the inventors of the present application found a method that can significantly suppress the bump portion 40, and conceived the present disclosure.

In other words, according to the one embodiment in the present disclosure, a method of manufacturing a glass substrate having a penetrating structure is provided, that includes:

(1) preparing a glass substrate that has a first surface and a second surface opposite to each other, and includes 3 mol % to 30 mol % of B₂O₃ in terms of oxide,
(2) having the glass substrate irradiated with a laser from a first surface side, to form an initial penetrating structure,
(3) wet etching the glass substrate having the initial penetrating structure formed,
(4) polishing the wet-etched glass substrate from the first surface side, by using an abrasive including acid-soluble abrasive grains, and
(5) cleaning the glass substrate with an acid solution.

According to the one embodiment in the present disclosure, after the wet etching process at (3), a polishing process of the first surface is carried out at (4), and by this step, a bump portion can be removed or reduced.

Note that in general, abrasive grains of cerium oxide are used as an abrasive for glass. However, in the case where the polishing process at (4) is carried out using such common abrasive grains, the likelihood of abrasive grains remaining inside a through hole increases.

However, according to the one embodiment in the present disclosure, in the polishing process at (4), an abrasive that includes acid-soluble abrasive grains is used. Therefore, according to the one embodiment in the present disclosure, even if abrasive grains remain inside a through hole, the abrasive grains included in the abrasive can be dissolved in the acid cleaning process at (5).

In this way, according to the one embodiment in the present disclosure, a glass substrate having a through hole in which formation of a bump portion is significantly suppressed, can be manufactured.

### (Method of Manufacturing a Glass Substrate According to the One Embodiment in the Present Disclosure)

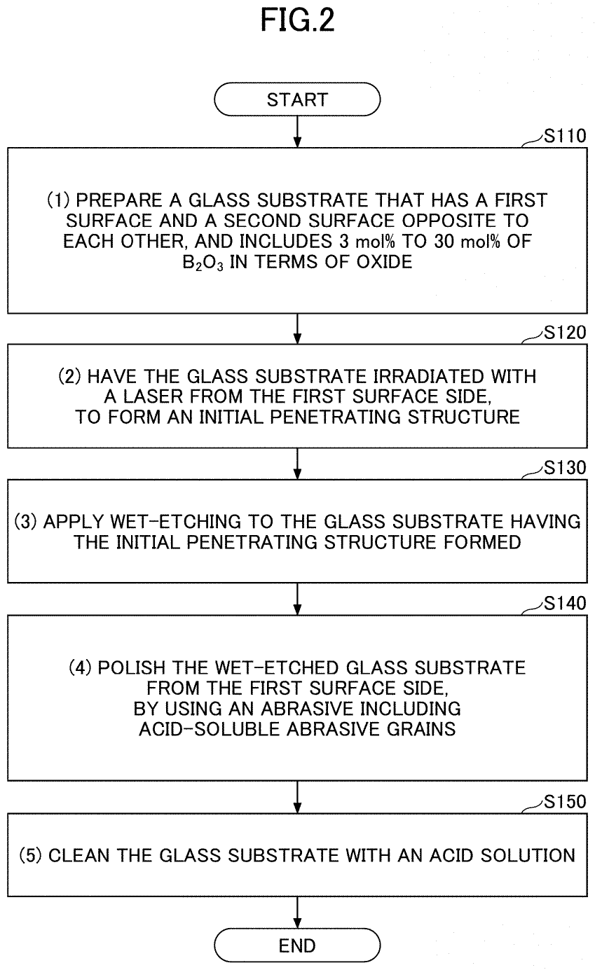

In the following, with reference to FIGS. 2 to 5, the method of manufacturing a glass substrate according to the one embodiment in the present disclosure will be described in more detail.

FIG. 2 schematically illustrates an example of a flow of the method of manufacturing a glass substrate according to the one embodiment in the present disclosure.

As illustrated in FIG. 2, the method of manufacturing a glass substrate according to the one embodiment in the present disclosure (hereafter, referred to as “the first method”) includes:

(1) a step of preparing a glass substrate that has a first surface and a second surface opposite to each other, and includes 3 mol % to 30 mol % of B₂O₃ in terms of oxide (Step S110),
(2) a step of having the glass substrate irradiated with a laser from a first surface side, to form an initial penetrating structure (Step S120),
(3) a step of wet etching the glass substrate having the initial penetrating structure formed (Step S130),
(4) a step of polishing the wet-etched glass substrate from the first surface side, by using an abrasive including acid-soluble abrasive grains (Step S140), and
(5) a step of cleaning the glass substrate with an acid solution (Step S150).

In the following, the respective steps will be described.

### (Step S110)

First, a glass substrate to be processed is prepared.

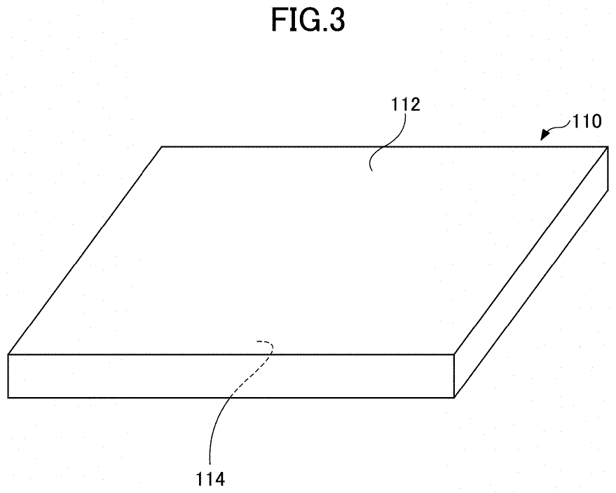

FIG. 3 is a diagram schematically illustrating an example of a glass substrate 110.

The glass substrate 110 has a first surface 112 and a second surface 114 opposite to each other.

The glass substrate 110 contains SiO₂ as the main component, and contains 3 mol % to 30 mol % of B₂O₃ in terms of oxide. The problem of bump portions may not be noticeable in the case where the content of B₂O₃ is less than 3 mol %. In addition, if the content of B₂O₃ exceeds 30 mol %, a problem arises in that the chemical durability of the glass decreases significantly

The content of B₂O₃ is, for example, greater than or equal to 5 mol %, and it is favorable to be greater than or equal to 10 mol %.

The thickness of the glass substrate 110 is not limited in particular, for example, within a range of 0.1 mm to 1 mm.

Note that the shape of the first surface 112 and the second surface 114 of the glass substrate 110 is not limited in particular, and the glass substrate 110 may be rectangular or disk-shaped.

### (Step S120)

Next, the glass substrate 110 is irradiated with a laser from the first surface 112 side, to form one, or two or more initial through holes in the glass substrate 110.

The laser to be used is not limited in particular, and may be, for example, a CO₂ laser. In the case of using the CO₂ laser, an initial through hole having a relatively large opening can be formed.

In general, irradiation with the CO₂ laser increases the heat input provided to the glass substrate 110. As a result, an alteration layer formed around an initial through hole also becomes more noticeable. However, as will be described later, even in such a case, the first method can significantly suppress formation of a bump portion in the end.

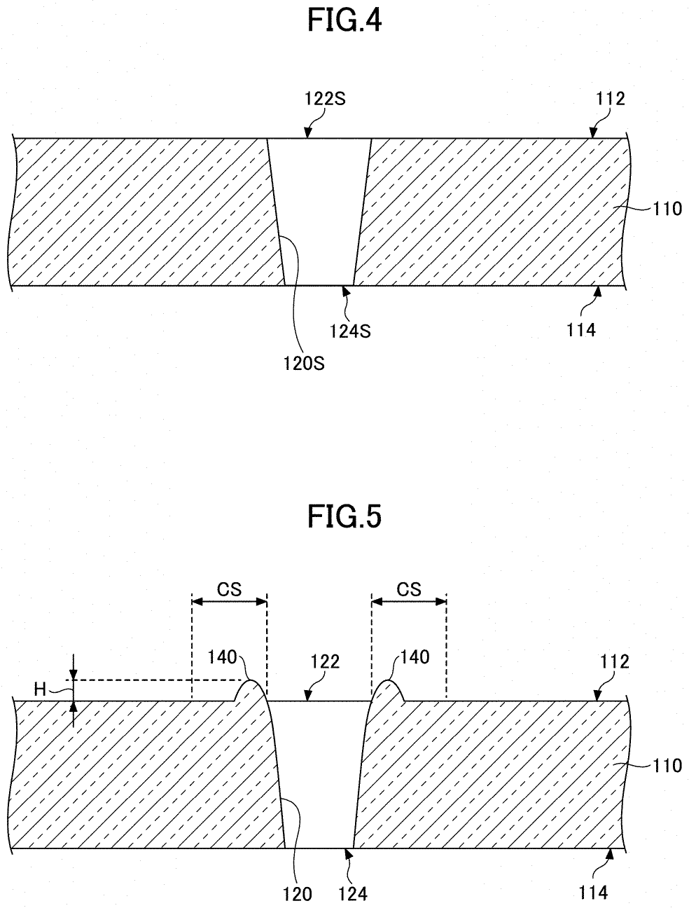

FIG. 4 is a diagram schematically illustrating a cross section of a glass substrate 110 in which an initial through hole 120S is formed.

The initial through hole 120S has a first initial opening 122S on the first surface 112 of the glass substrate 110, and a second initial opening 124S on the second surface 114.

The shapes and dimensions of the first initial opening 122S and the second initial opening 124S are not limited in particular. The first initial opening 122S is approximately circular, and may have a diameter, for example, within a range of 10 μm to 50 μm. Similarly, the second initial opening 124S is approximately circular, and may have a diameter, for example, within a range of 10 μm to 50 μm.

Note that the initial through hole 120S does not necessarily correspond to the focal shape of the laser to be used for irradiation. For example, a greater initial through hole 120S may be formed by annularly joining and hollowing out multiple laser holes. Also, an initial groove may be formed instead of the initial through hole 120S by linearly joining the multiple laser holes. Further, a polygonal initial penetrating structure having greater dimensions may be formed by joining and hollowing out multiple laser holes into a polygonal frame shape.

### (Step S130)

Next, the glass substrate 110 is wet etched. Accordingly, from the initial through hole 120S, a through hole adjusted to have a desired shape can be formed. Also, the thickness of the glass substrate 110 can be adjusted to have a desired thickness.

Any conventional common method can be used for the wet etching process. For example, as the etching solution, a hydrofluoric acid solution may be used.

Note that the first surface 112 and the second surface 114 of the glass substrate 110 are also etched by the wet etching process. Therefore, after Step S130, both surfaces of the glass substrate 110 become newly formed surfaces. However, in the present application, in order to avoid complications, even after Step S130, both surfaces of the glass substrate 110 are still referred to as the “first surface 112” and the “second surface 114”.

FIG. 5 is a diagram schematically illustrating a cross section of the glass substrate 110 after the wet etching process.

As illustrated in FIG. 5, the initial through hole 120S becomes a through hole 120 by the wet etching process. The through hole 120 has a first opening 122 on the first surface 112 and a second opening 124 on the second surface 114.

The first opening 122 is approximately circular, and may have a diameter, for example, within a range of 50 μm to 200 μm. Substantially the same is applied to the second opening 124.

As described above, a bump portion 140 is formed in the surrounding region CS of the first opening 122 of the through hole 120 after the wet etching process.

The shape and the height H of the bump portion 140 vary depending on the composition of the glass substrate 110, conditions of laser irradiation, conditions of etching, and the like. For example, for a glass substrate 110 including 20 mol % of B₂O₃ in terms of oxide, in the case of using the CO₂ laser, the height H of the bump portion 140 could be within a range of 0.5 μm to 5 μm.

Note that on the first surface 112 and the second surface 114 of the glass substrate 110 after the wet etching process, the arithmetic mean roughness Ra of an area excluding the first opening 122 and the surrounding region CS is normally greater than or equal to 2 nm.

### (Step S140)

Next, the first surface 112 of the glass substrate 110 is polished. Accordingly, the bump portion 140 present in the surrounding region CS can be removed or reduced.

The method of polishing is not limited in particular, and a chemical mechanical polishing (CMP) or the like can be used. In the CMP method, an object to be polished is polished on a polishing pad in a state of a slurry including abrasive being supplied. The CMP method is also adopted in a flattening process of surfaces of semiconductor wafers, by which extremely smooth polished surfaces can be obtained.

In the case of adopting the CMP method, as the polishing pad, for example, hard urethane, suede, and nonwoven fabric, or the like may be used.

The amount of polishing is normally within a range of 0.1 to 5 μm, although it depends on the height H of the bump portion 140.

Here, in the first method, acid-soluble abrasive grains are used as the abrasive.

The abrasive may contain one, or two or more substances selected from among, for example, calcium carbonate, zinc oxide, and manganese oxide. Calcium carbonate is soluble in common acids, such as hydrochloric acid and nitric acid. Zinc oxide dissolves, for example, in organic acid such as acetic acid, malic acid, or citric acid; or in common inorganic acid such as hydrochloric acid, nitric acid, or sulfuric acid. Also, manganese oxide is soluble in ascorbic acid.

### (Step S150)

Next, the glass substrate 110 is cleaned with an acid solution. Accordingly, the abrasive grains remaining in the through hole 120 can be removed.

The acid solution to be used is selected appropriately in accordance with the acid-soluble abrasive grains used at Step S140.

Note that it is favorable to carry out this cleaning step within as short a period of time as possible, as long as remaining abrasive grains can be removed. In the case where the cleaning step is carried out for such a proper time, it becomes less likely that the first surface 112 and the second surface 114 of the glass substrate 110 would become rough, and smooth surfaces can be obtained on both sides.

The first surface 112 after Step S150 may have an arithmetic mean roughness Ra of, for example, less than or equal to 1 nm.

By the above steps, a glass substrate on which a bump portion is significantly suppressed can be manufactured.

### (Method of Manufacturing Glass Substrate According to Another Embodiment in the Present Disclosure)

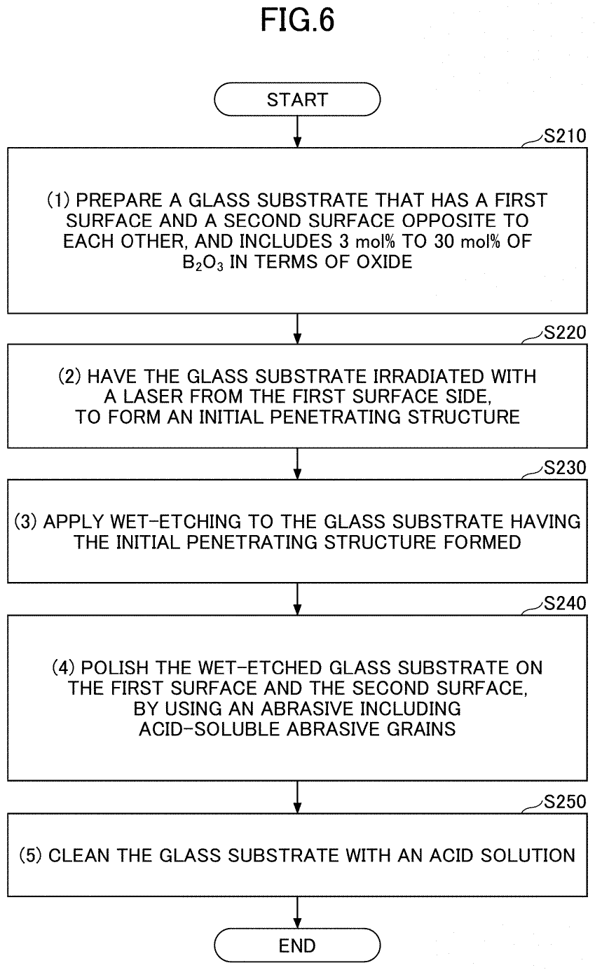

Next, with reference to FIG. 6, a method of manufacturing a glass substrate according to another embodiment in the present disclosure will be described.

FIG. 6 schematically illustrates an example of a flow of the method of manufacturing a glass substrate according to the other embodiment in the present disclosure.

As illustrated in FIG. 6, the method of manufacturing a glass substrate according to the other embodiment (hereafter, referred to as “the second method”) in the present disclosure includes:

(1) a step of preparing a glass substrate that has a first surface and a second surface opposite to each other, and includes 3 mol % to 30 mol % of B₂O₃ in terms of oxide (Step S210),
(2) a step of having the glass substrate irradiated with a laser from a first surface side, to form an initial penetrating structure (Step S220),
(3) a step of wet etching the glass substrate having the initial penetrating structure formed (Step S230),
(4) a step of polishing the wet-etched glass substrate on the first surface and the second surface, by using an abrasive including acid-soluble abrasive grains (Step S240), and
(5) a step of cleaning the glass substrate with an acid solution (Step S250).

In the second method, Steps S210 to S230 and S250 are substantially the same as in the first method described above. Therefore, Step 240 will be described here.

### (Step S240)

At Step S240, both of the first surface and the second surface of the glass substrate are polished. The first surface and the second surface may be polished simultaneously using, for example, a double-side polisher or the like.

Accordingly, a bump portion present in a surrounding region CS on the first surface can be removed or reduced. Also, the second surface can also be flattened.

The method of polishing and the like are substantially the same as in the case of the first method described above. In particular, the abrasive may contain one, or two or more substances selected from among, for example, calcium carbonate, zinc oxide, and manganese oxide.

At the subsequent Step S250, the glass substrate is cleaned with an acid solution as in the first method described above. Accordingly, the abrasive grains remaining in the through hole can be removed.

Also in the second method, by the above steps, a glass substrate on which a bump portion is significantly suppressed can be manufactured.

In the second method, after Step S250, relatively smooth first and second surfaces can be obtained. For example, the first surface and the second surface of the glass substrate after Step S250 may have an arithmetic mean roughness Ra of less than or equal to 1 nm.

Note that the above description is merely an example, and the first method and the second method can be modified in various ways in the respective steps. For example, in the first method described above, processing on the second surface 114 of the glass substrate 110 is not specifically mentioned. However, in the first method, a process of polishing the second surface 114 of the glass substrate may be carried out after Step S140 or after Step S150. Other than this, various changes can be considered.

### (Glass Substrate According to One Embodiment in the Present Disclosure)

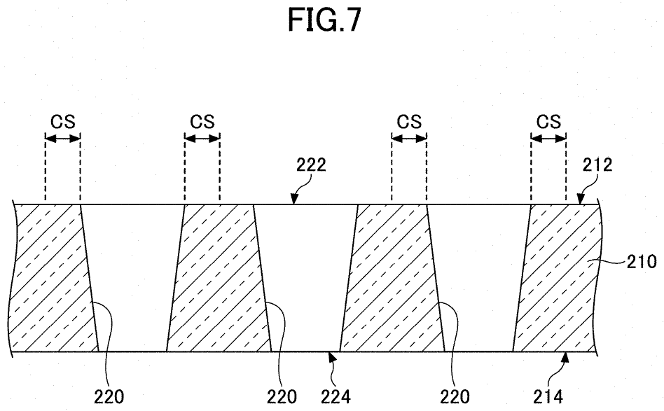

Next, with reference to FIG. 7, a glass substrate according to one embodiment in the present disclosure will be described.

FIG. 7 schematically illustrates a cross section of a glass substrate according to the one embodiment in the present disclosure (hereafter, referred to as the “first glass substrate” 210).

As illustrated in FIG. 7, the glass substrate 210 has a first surface 212 and a second surface 214 opposite to each other.

The thickness of the first glass substrate 210 is not limited in particular, for example, within a range of 0.1 mm to 1 mm.

The first glass substrate 210 contains SiO₂ as the main component, and contains 3 mol % to 30 mol % of B₂O₃ in terms of oxide. The content of B₂O₃ is greater than or equal to 5 mol %, and it is favorable to be greater than or equal to 10 mol %.

In addition, the first glass substrate 210 has one, or two or more through holes 220 penetrating from the first surface 212 to the second surface 214. The through hole 220 has a first opening 222 on the first surface 212 and a second opening 224 on the second surface 214.

The first opening 222 is, for example, approximately circular, and may have a diameter of greater than or equal to 50 μm. Similarly, the second opening 224 is, for example, approximately circular, and may have a diameter of greater than or equal to 50 μm.

Note that the shape of the first surface 212 and the second surface 214 of the first glass substrate 210 is not limited in particular, and the glass substrate 210 may be rectangular or disk-shaped.

As illustrated in FIG. 1 described above, in the case where a through hole 20 is formed in a glass substrate 10 including a predetermined amount of B₂O₃ by a laser irradiation step followed by a wet etching step, a bump portion 40 may be generated in a surrounding region CS outside an opening 22 on the surface (first surface 12) on the laser incidence side. Such a bump portion 40 may cause a problem when applying the glass substrate 10 to a glass interposer or the like.

However, the first glass substrate 210 has a characteristic that the maximum height in the surrounding region CS is higher than or equal to 0 μm and less than or equal to 1 μm on the first surface 212. In addition, the first glass substrate 210 has a characteristic that the arithmetic mean roughness Ra of less than or equal to 1 nm in a region outside the surrounding region CS on the first surface 212.

The first glass substrate 210 having such characteristics can be properly used, for example, in a glass interposer, a laminate, or the like.

In other words, in the case of using the first glass substrate 210 as a glass interposer, first, a thin seed layer is formed inside the first surface 212 and the through hole 220, as a base layer for plating. In this case, as no significant bump portion is present on the first surface 212 of the first glass substrate 210, the seed layer can be properly (non-intermittently) arranged at desired positions on the first surface. Therefore, in the subsequent plating step of a conductive member, the conductive member can be properly arranged.

Also, in the case where the first glass substrate 210 is joined with another member to form a laminate, a sufficient bond strength is obtained at the interface between the first surface 212 and the other member, and occurrence of delamination can be significantly suppressed. This is because there are no bump portions on the first surface 212, and the arithmetic mean roughness Ra of the first surface 212 is less than or equal to 1 nm, and hence, the surface is smooth.

Further, the first glass substrate 210 may have a characteristic that, on the second surface 214, the arithmetic mean roughness Ra is less than or equal to 1 nm in a region outside a second surrounding region.

Here, the “second surrounding region” is a region in the first glass substrate 210, up to 10-μm outward from the contour of a second opening 224, as viewing the through hole 220 from the second opening 224 side.

In this way, in the first glass substrate 210, the problems related to the conventional glass substrate 10 as described above can be significantly suppressed.

### APPLICATION EXAMPLES

Next, application examples in the present disclosure will be described.

### Example 1

A glass substrate having a through hole was produced by the following method.

First, a plate-shaped glass substrate having a thickness of 0.5 mm was prepared. The glass substrate was an alkali-free glass that contains 62 mol % of SiO₂, 9 mol % of Al₂O₃, 21 mol % of B₂O, 7 mol % of SrO, and 1 mol % of BaO in terms of oxide.

Next, this glass substrate was irradiated with the CO₂ laser from one surface (first surface) side, to form an initial through hole. The power of the laser was 9 W and the incident NA was 0.20. Accordingly, an approximately circular first opening was formed on the first surface of the glass substrate, and an approximately circular second opening was formed on a surface (second surface) opposite to the first surface. The diameter of the first opening was approximately 80 μm, and the diameter of the second opening was approximately 30 μm.

Next, the glass substrate was wet etched. Specifically, the glass substrate was immersed in a processing solution for 55 minutes. As the processing solution, a solution containing 1 wt % of HF and 2 wt % of HCl was used. Accordingly, the thickness of the glass substrate was reduced by approximately 40 μm.

Next, a laser microscope (OLS 5000, manufactured by Olympus Corporation) was used for measuring the shape around the first opening on the etched glass substrate.

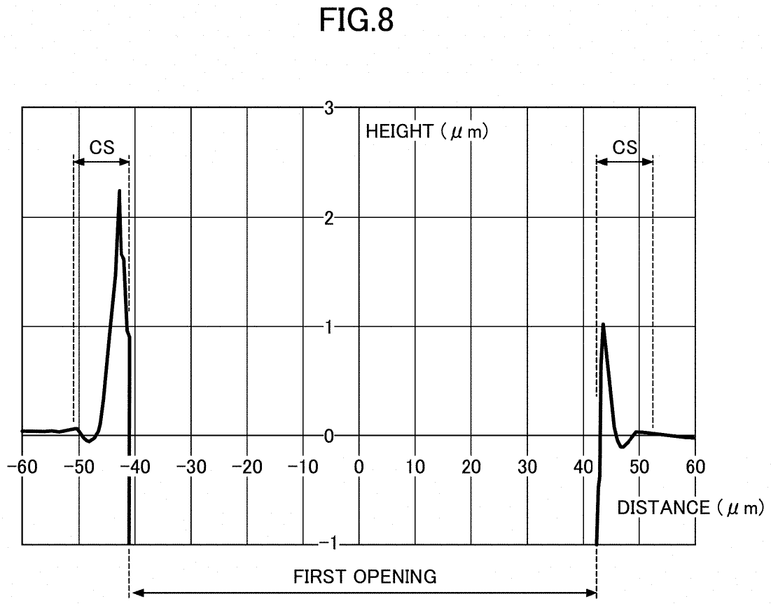

FIG. 8 illustrates measurement results. FIG. 8 illustrates a profile of the first opening and its vicinity along a cross section through the center of the through hole. In FIG. 8, the horizontal axis represents the distance from an origin set at the center of the first opening. Also, the vertical axis represents the height profile of the first surface.

From FIG. 8, it can be seen that a bump portion was generated in the vicinity of the circumference of the first opening, i. e., in the surrounding region CS. The bump portion had a height H of up to 2.4 μm.

Also, an atomic force microscope (AFM) instrument (manufactured by Bruker Corporation) was used for measuring the surface roughness on the first surface of the glass substrate (excluding the surrounding region CS) after the etching process. The measurement area was a discretionarily selected area of 10 μm by 10 μm.

As a result of measurement, the arithmetic mean roughness Ra was 2.2 nm.

Next, both of the first surface and the second surface of the glass substrate were polished by the CMP method.

Hard urethane was used for the polishing pad. In addition, abrasive grains of calcium carbonate (mean particle size of 2.7 μm) were used as the abrasive. The polishing time was set to 15 minutes. Note that the mean particle size is a median diameter (D50) of a volumetric reference particle size distribution before polishing, as measured by laser diffraction scattering.

After the polishing process, the polished first surface was measured again using the laser microscope described above.

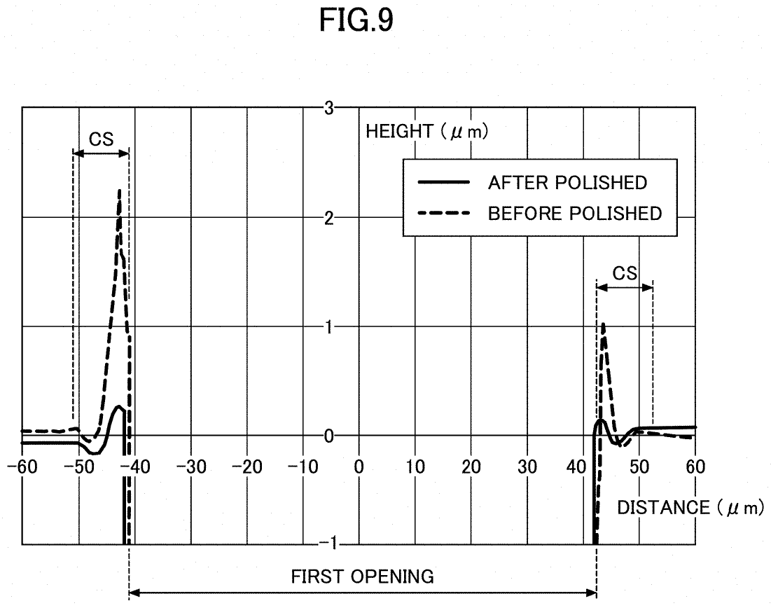

FIG. 9 illustrates measurement results. The vertical axis and the horizontal axis in FIG. 9 are the same as those in FIG. 8 described above. Also, FIG. 9 also illustrates a profile (dashed lines) of the first surface before polishing described above.

From FIG. 9, it can be seen that the bump portion was removed by the polishing process, and a smooth first surface was formed. The maximum height of the first surface in the surrounding region CS was approximately 0.27 μm.

In addition, by using the AFM instrument described above, the surface roughness of the first surface (non-surrounding region) after polishing was measured again. As a result, it was confirmed that the arithmetic mean roughness Ra of the first surface was reduced down to 0.4 nm.

Next, the acid cleaning process of the glass substrate was carried out at 30° C. As the cleaning solution, 0.1 mol/L of nitric acid was used, and the cleaning time was set to 30 minutes.

When the inside of each through hole was observed after the cleaning process, no remaining abrasive grains of calcium carbonate were found. Therefore, it was found that the acid cleaning process could remove abrasive grains sufficiently.

By using the AFM instrument described above, the surface roughness of the first surface after the cleaning process was measured again. As a result, it was found that the arithmetic mean roughness Ra of the first surface was 0.4 nm, and had changed little from that before cleaning.

### Example 2

A glass substrate having a through hole was prepared by substantially the same method as in Example 1. However, in this example 2, a polishing pad of suede was used during the CMP process. The other conditions are substantially the same as in Example 1.

When the inside of each through hole was observed after the cleaning process, no remaining abrasive grains of calcium carbonate were found. Therefore, it was found that the acid cleaning process could remove abrasive grains sufficiently.

### Example 3

A glass substrate having a through hole was prepared by substantially the same method as in Example 1. However, in this example 3, a polishing pad of nonwoven fabric was used during the CMP process. The other conditions are substantially the same as in Example 1.

When the inside of each through hole was observed after the cleaning process, no remaining abrasive grains of calcium carbonate were found. Therefore, it was found that the acid cleaning process could remove abrasive grains sufficiently.

Table 1 below summarizes the height H of the bump portion on the first surface of each of the glass substrates obtained in Examples 1 to 3, before polishing and after acid cleaning.

TABLE 1

| | Height H (μm) | | |
|---|---|---|---|
| | | Before | After |
| Example | Polishing pad | polishing process | acid-cleaning |
| 1 | Hard urethane | 2.4 | 0.27 |
| 2 | Suede | 2.3 | 0.54 |
| 3 | Nonwoven fabric | 1.7 | 0.16 |

In this way, it was confirmed that the bump portion can be significantly reduced by applying the polishing process after the etching process. It was also confirmed that in the case of using acid-soluble abrasive grains, the problem of abrasive grains remaining in a through hole could be avoided by executing the acid-cleaning process after the polishing process.

Table 2 below summarizes the surface roughness of the first surface of each of the glass substrates obtained in Examples 1 to 3, before polishing and after acid cleaning.

TABLE 2

| | Surface roughness Ra (nm) | | |
|---|---|---|---|
| | | Before | After |
| Example | Polishing pad | polishing process | acid-cleaning |
| 1 | Hard urethane | 0.4 | 0.4 |
| 2 | Suede | 0.6 | 0.6 |
| 3 | Nonwoven fabric | 0.4 | 0.4 |

In Examples 1 to 3, it was found that the surface roughness (Ra) of the first surface of the glass substrate after acid cleaning had changed little from that before polishing.

Similarly, in Examples 1 to 3, the surface roughness (Ra) of the second surface after acid cleaning, excluding the second surrounding region, was less than or equal to 1 nm in all Examples.

### Example 11

A glass substrate having a through hole was prepared by substantially the same method as in Example 1. However, in this Example 11, abrasive grains of cerium oxide (average grain size 0.8 μm) were used as the abrasive during the polishing process by the CMP method. In addition, after the polishing process, the glass substrate was cleaned using an alkaline solution instead of an acid solution. The other conditions are substantially the same as in Example 1.

For the glass substrate after the etching process, the shape around the first opening was measured.

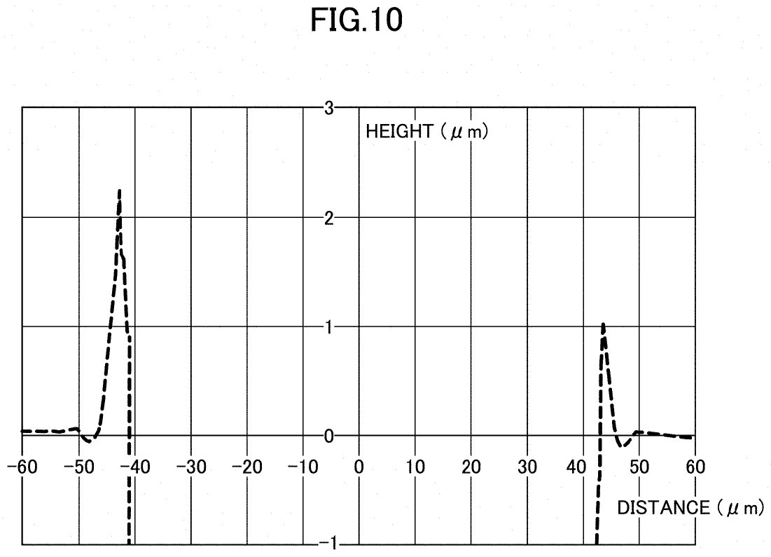

FIG. 10 illustrates measurement results. FIG. 10 illustrates a profile of the first opening and its vicinity along a cross section through the center of the through hole. In FIG. 10, the horizontal axis represents the distance from an origin set at the center of the first opening. Also, the vertical axis represents the height profile of the first surface.

From FIG. 10, it can be seen that a bump portion was generated in the vicinity of the circumference of the first opening, i. e., in the surrounding region CS. The bump portion had a height H of up to 2.2 μm.

Next, the first surface of the glass substrate was polished by the CMP method. Hard urethane was used for the polishing pad. In addition, abrasive grains of cerium oxide (mean grain size of 0.8 μm) were used as the abrasive. The polishing time was set to 15 minutes.

After the polishing process, an alkali cleaning process of the glass substrate was carried out at 30° C. As the cleaning solution, an alkaline detergent whose pH was adjusted to 11.9 was used, and the cleaning time was set to 2 minutes.

After the cleaning process, the inside of each through hole was observed.

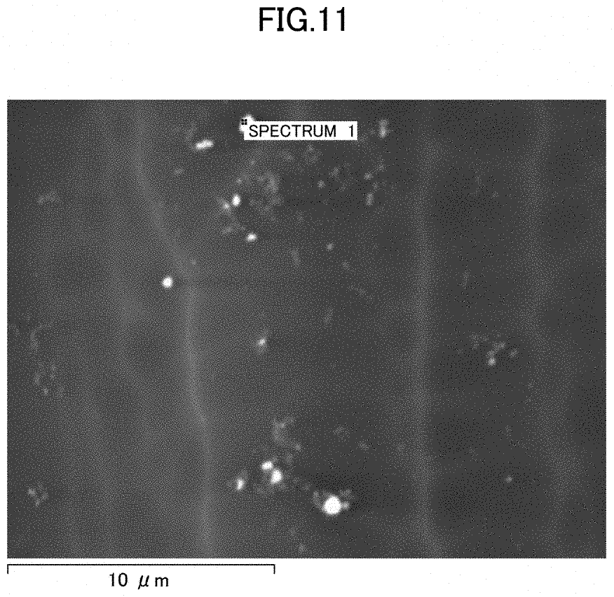

FIG. 11 illustrates an example of a result of SEM-EDX analysis of the inner wall of the through hole. As illustrated in FIG. 11, it was confirmed that a large number of abrasive grains of cerium oxide (particles that appear white in the figure) remained inside the through hole.

1. A method of manufacturing a glass substrate having a penetrating structure, the method comprising:
(1) preparing a glass substrate that has a first surface and a second surface opposite to each other, and includes 3 mol % to 30 mol % of B₂O₃ in terms of oxide;
(2) having the glass substrate irradiated with a laser from a first surface side, to form an initial penetrating structure;
(3) wet etching the glass substrate having the initial penetrating structure formed;
(4) polishing the wet-etched glass substrate from the first surface side, by using an abrasive including acid-soluble abrasive grains; and
(5) cleaning the glass substrate with an acid solution.

2. A method of manufacturing a glass substrate having a penetrating structure, the method comprising:
(1) preparing a glass substrate that has a first surface and a second surface opposite to each other, and includes 3 mol % to 30 mol % of B₂O₃ in terms of oxide;
(2) having the glass substrate irradiated with a laser from a first surface side, to form an initial penetrating structure;
(3) wet etching the glass substrate having the initial penetrating structure formed;
(4) polishing the wet-etched glass substrate on the first surface and the second surface, by using an abrasive including acid-soluble abrasive grains; and
(5) cleaning the glass substrate with an acid solution.

3. The method of manufacturing as claimed in claim 1, wherein in said (4), the first surface side of the glass substrate is polished by an abrasive amount between 0.1 and 5 μm.

4. The method of manufacturing as claimed in claim 1, wherein the laser is a CO₂ laser.

5. The method of manufacturing as claimed in claim 1, wherein an opening on the first surface side of the initial penetrating structure is approximately circular, and has a diameter of greater than or equal to 50 μm.

6. The method of manufacturing as claimed in claim 1, wherein after said (5), a surface having an arithmetic mean roughness Ra of less than or equal to 1 nm is obtained on the first surface side of the glass substrate.

7. The method of manufacturing as claimed in claim 1, wherein the acid-soluble abrasive grains contain at least one of substances selected from among a group consisting of calcium carbonate, zinc oxide, and manganese oxide.

8. The method of manufacturing as claimed in claim 1, wherein before executing processing of said (4), the first surface side of the glass substrate has a surface having an arithmetic mean roughness Ra exceeding 1 nm.

9. A glass substrate comprising:
a first surface and a second surface opposite to each other,
wherein the glass substrate contains 3 mol % to 30 mol % of B₂O₃ in terms of oxide, and has a penetrating structure that penetrates from the first surface to the second surface,
wherein the penetrating structure has a first opening on the first surface, and as viewed from a first surface side, when a region up to 10-μm outward from a contour of the first opening is referred to as a surrounding region, a maximum height in the surrounding region is greater than or equal to 0 μm and less than or equal to 1 μm, and
wherein an arithmetic mean roughness Ra is less than or equal to 1 nm in a region outside the surrounding region of the first surface.

10. The glass substrate as claimed in claim 9, wherein the penetrating structure has a second opening on the second surface, and
wherein when the penetrating structure is viewed from a second surface side, an area up to 10-μm outward from a contour of the second opening is referred to as a second surrounding region, a region outside the second surrounding region of the second surface has an arithmetic mean roughness Ra of less than or equal to 1 nm.

11. The glass substrate as claimed in claim 9, wherein the first opening of the penetrating structure is approximately circular, and has a diameter of greater than or equal to 50 μm.
